(19) United States
(12) Patent Application Publication
(10) Pub. No.: US 2014/0236724 A1
(43) Pub. Date: Aug. 21, 2014

(54) MESSAGING SERVICE FOR LOCATION-AWARE MOBILE RESOURCE MANAGEMENT AND ADVERTISEMENTS WITH A MOBILE DEVICE TRIGGERED BY TAGGED USER-GENERATED MESSAGES

(71) Applicant: SHAILENDRA JAIN, Palo Alto, CA (US)

(72) Inventor: SHAILENDRA JAIN, Palo Alto, CA (US)

(21) Appl. No.: 13/769,806

(22) Filed: Feb. 18, 2013

(51) Int. Cl. G06Q 30/02; H04W 4/14

(52) U.S. Cl. CPC G06Q 30/0261; H04W 4/14
USPC 705/14.58; 455/466

(57) ABSTRACT

In one exemplary embodiment, a method includes receiving a text message from a mobile device. The text message includes a tag entered into the text portion of the message. The tag includes a term assigned to a server-side process. A location of the mobile device is obtained. The server-side process is determined based on the tag and the location of the mobile device. The server-side process is implemented. An instruction to a user of the mobile device is composed. The instruction is formatted into a text message format.

### CROSS-REFERENCE TO RELATED APPLICATIONS

This application is a claims priority to U.S. patent provisional application no. 61/600,706 titled MESSAGING SERVICE FOR LOCATION-AWARE MRM AND/OR ADVERTISEMENTS WITH A MOBILE DEVICE TRIGGERED BY TAGGED USER-GENERATED MESSAGES and filed on Feb. 19, 2012. This provisional application is hereby incorporated by reference in its entirety.

### BACKGROUND

1. Field

This application relates generally to enhanced messaging services, and more particularly to a system, method and article of manufacture of manufacture of user-tagged messaging service for location-aware MRM and/or advertisements on a mobile device triggered by tagged user-generated messages.

2. Related Art

Mobile resource management (MRM) may allow an enterprise to remotely manage assets (e.g. equipment, personnel) with information from mobile devices. Likewise, advertisement campaigns may be more effective if the advertiser is aware of the customer's current location. However, such systems may require that additional specialized software and/or hardware be installed in the mobile devices in order to track the user's current location and/or status (e.g. user would like to receive advertisements; user would like address of next job, etc.). This additional specialized software and/or hardware can be costly to purchase, install and maintain. For example, an enterprise may own thousands of mobile devices. The cost of updating the MRM application software in all these mobile devices can be onerous. In another example, a location-aware advertisement enterprise may lose clients who fail to implement occasional software updates. Moreover, the additional specialized software and/or hardware may also be drain on the power and processing resources of the mobile device. Thus, a need exists for a system that utilizes the native location and communication capabilities of the device to create a user-tagged, text message (e.g. SMS, MMS and the like) based location-enhanced MRM and for location-based ad campaigns which properly accounts for user permissions, preferences, position and time.

### BRIEF SUMMARY OF THE INVENTION

In one aspect, a method includes receiving a text message from a mobile device. The text message includes a tag entered into the text portion of the message. The tag includes a term assigned to a server-side process. A location of the mobile device is obtained. The server-side process is determined based on the tag and the location of the mobile device. The server-side process is implemented. An instruction to a user of the mobile device is composed. The instruction is formatted into a text message format.

Optionally, the server-side process can be a location-aware advertisement campaign. The location-aware advertisement campaign can include the step of determining a substantially current geozone of the mobile device based on the location of the mobile device. The substantially current geozone can be matched with at least one advertisement. The advertisement can pertain to a business entity located in the substantially current geozone. The advertisement can be formatted into a text message format. The advertisement can be communicated to a text messaging application in the mobile device. The server-side process can include a mobile-resource management process. The mobile device may not comprise a specialized mobile resource management client application. The mobile-resource management process can include the step of determining at least one mobile resource management instruction based on the location of the mobile device. A location-aware mobile resource management message can be generated based on the least one mobile resource management instruction.

### BRIEF DESCRIPTION OF THE DRAWINGS

The present application can be best understood by reference to the following description taken in conjunction with the accompanying figures, in which like parts may he referred to by like numerals.

FIG. 1A depicts an example process of a messaging service for location-aware advertisements with a mobile device triggered by tagged user-generated messages, according to some embodiments.

FIG. 1B depicts an example process of a messaging service for location-aware MRM with a mobile device triggered by tagged user-generated messages, according to some embodiments.

FIG. 2 is a block diagram of a sample computing environment that can be utilized to implement some embodiments.

FIG. 3 depicts an exemplary computing system that can be configured to perform any one of the processes provided herein.

FIG. 4 depicts air example location-aware MRM according to some embodiments.

FIG. 5 depicts an example location-aware system utilized for location-aware advertisement campaigns, according to some embodiments.

FIG. 6 depicts a table with a set of example MRM-related user tags and corresponding interpretations for the rule engine, according to some embodiments.

FIG. 7 depicts a table with a set of example location-aware advertisement campaign-related user tags and corresponding interpretations for the rule engine, according to some embodiments.

FIG. 8 illustrates several exemplary user-side mobile device screen shots, according to some embodiments.

FIG. 9 illustrates several exemplary user-side mobile device screen shots including a pull-based, location-specific advertisement and/or coupons, according to some embodiments.

The Figures described above are a representative set, and are not an exhaustive with respect to embodying the invention.

### DESCRIPTION

Disclosed are a system, method, and article of manufacture of user-tagged messaging service for location-aware MRM and/or advertisements on a mobile device triggered by tagged user-generated messages. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout his specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily; all refer to the same embodiment.

Furthermore, the described features, structures, or characteristics of the invention may be combined in any suitable manner in one or more embodiments. In the Mowing description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally the order in which a particular method occurs may or may not strictly adhere to the order of the corresponding steps shown.

### Process Overview

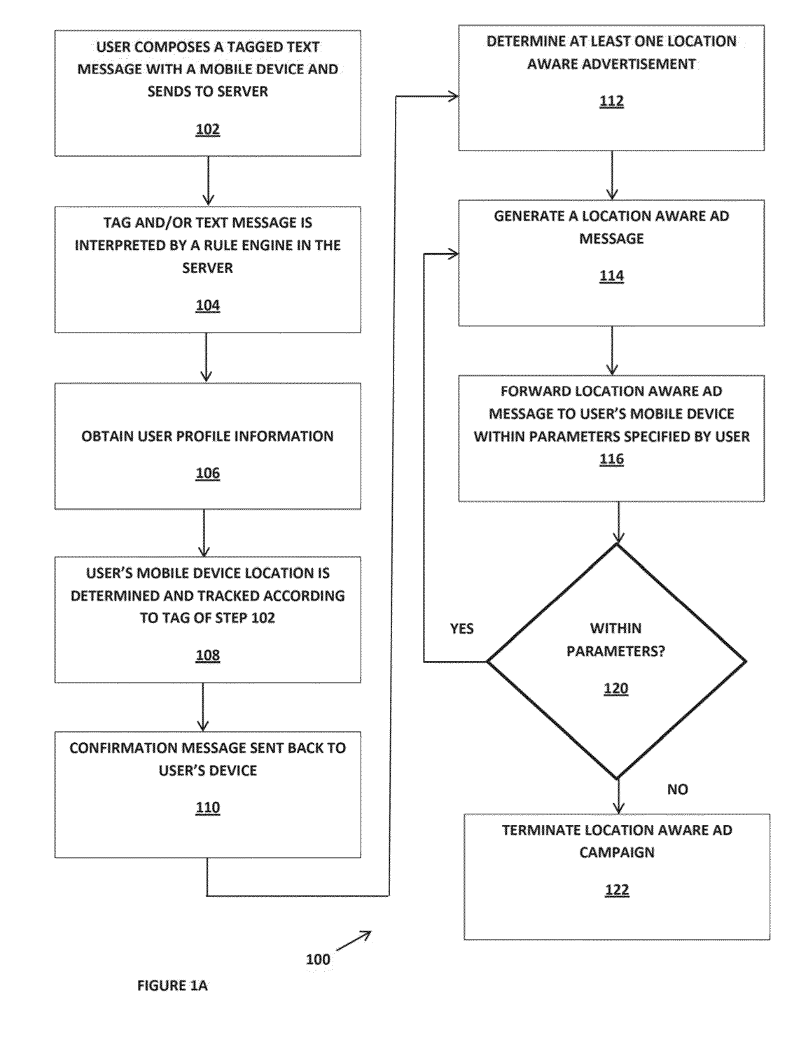

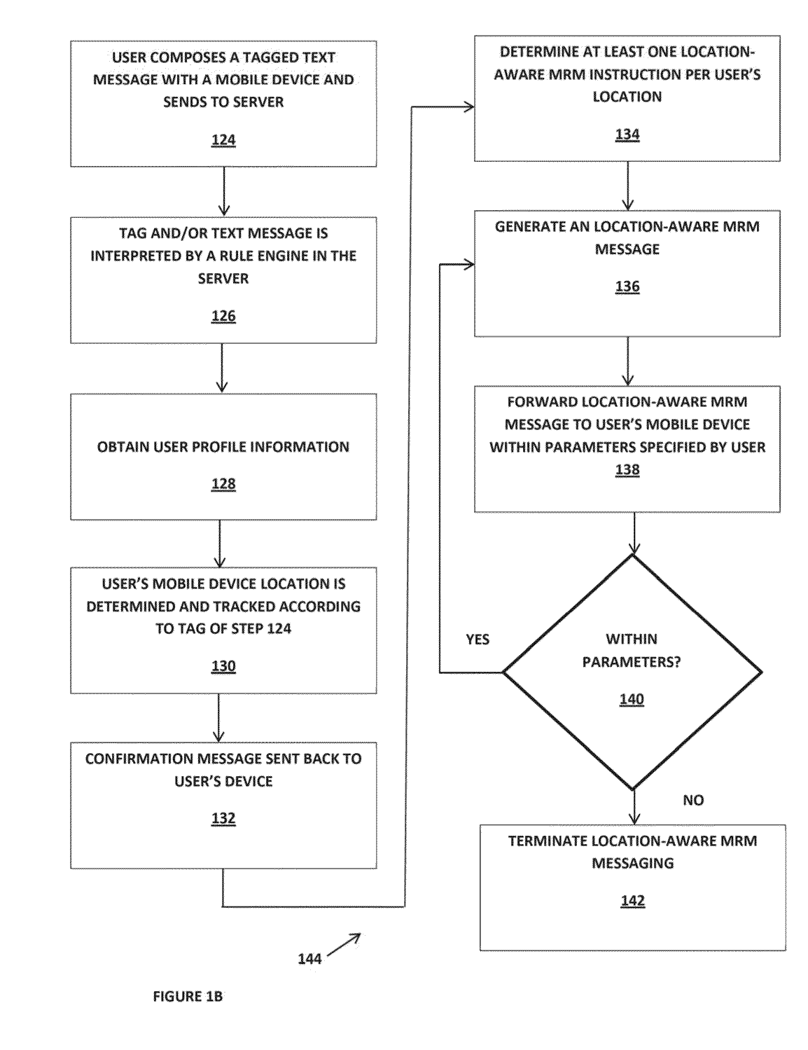

FIG. 1A depicts an example process 100 of a messaging service for location-aware advertisements with a mobile device triggered by tagged user-generated messages, according to some embodiments. In step 102 of process 100, a user composes a tagged text message with a mobile device and sends the tagged text message to a server. The server can be a location-aware advertisement campaign application server. As used herein, a mobile device can be a hand-held computing device such as a smart phone, personal-digital assistance, tablet computer, mobile phone and the like (e.g. iPhone®, Android™). A text message can include such messaging services as a short message service (SMS), multimedia messaging service (MMS), enhanced messaging service (EMS) message, an extension of SMS, an extension of MMS, and the like. In the example of SMS (or an extension thereof), the location-aware advertisement campaign application server can operate independently of a short message service center (SMSC) server (e.g. be communicatively coupled with the SMSC via the Internet, connect to a messaging gateway) and/or be incorporated into an SMSC server (e.g. as a local value-added service (VAS) server), according various embodiments. The tag can include an alpha-numeric and/or symbolic code that is entered into the text portion of the message. A user can utilize various tags to instruct the location-aware advertisement campaign application server to implement a location-aware advertisement campaign according to various parameters (e.g. while the user is in a particular location and/or for a specified period of time). In some embodiments, these parameters can be preloaded by the user (and/or another party such as a system administrator and/or an advertiser) via a web interface that allows the user to provide profile information and/or preferences to the location-aware advertisement campaign application server (see infra). In some embodiments, these parameters can be specified by the user in the text message as a tag or portion thereof (see infra). It is noted that the SMSC can be configured to forward a tagged text message to the location-aware advertisement campaign application server for parsing and analysis.

Additionally, the user's tags can serve as instructions to the rule engine as to which conditions such as when, what, where and how to communicate advertisements to the user via text messages to the user's mobile device. Tags can indicate various levels of granularity in types of advertisements and/or incentives (e.g. coupons) that can be sent to the user's mobile device. For example, a tag can indicate a user wants all available advertisements in a particular geozone, only available food related coupons in a geozone, or only coffee-related advertisements in a geozone, and the like. Tag semantics and/or content can be interpreted by the rule engine and dictate actions of location-aware advertisement campaign (and/or MRM system see infra).

In step 104, a rule engine (such as a module in the location-aware advertisement campaign application server) can then interpret the tag(s) and/or message content. The rule engine can also utilize other metadata such as information from the mobile device's network, location information, user profile information and the like. Thus, in step 106, the profile information of the user is obtained. The rule engine can utilize the tags, message content and/or metadata to determine an appropriate location-aware advertisement campaign to send to the user's mobile device.

In step 108, the user's mobile device location is determined and tracked. Step 108 can be triggered and performed according to a tag input by the user in tagged text message in step 102 instructing the location-aware advertisement campaign application server to track the user's mobile device. Thus, in some embodiments, location tracking can be initiated when start location tracking only when initiated by user-generated tag. The mobile device's location can be tracked with any available geolocation methodology such as global positioning system (GPS), assisted GPS (aGPS), GSM localization, Near LBS (NLBS) (e.g. in which local-range technologies such as Bluetooth, WLAN, infrared and/or RFID/Near Field Communication technologies are used to match devices to nearby services), other network-based techniques utilize the service provider's network. infrastructure to identify the location of the mobile device, etc. It is noted that the geolocation methodology does not necessarily depend on the installation of additional software/hardware in the mobile device. In other words, the geolocation methodology can utilize native functionalities in the mobile device and/or network to track location. The location-aware advertisement campaign application server can include a tracking module that tracks subscribing mobile devices. For example, it can be determined if a user's mobile device is within a particular geozone. Advertisements relevant to the geozone can then be provided to the user via text messages to the mobile device see step 112-116 infra).

In step 110, a confirmation message can be sent back to the user's mobile device. The confirmation message can indicate such conditions as confirming that the location-aware advertisement campaign has been initiated, confirming that the instructions indicated by the tag(s) have been received and/or any parameters of the location-aware advertisement campaign (e.g. geozone location of advertisement campaign, time period of location-aware advertisement campaign, etc.)

In step 112, at least one relevant location-aware advertisement is determined according to such factors as the user's location, advertising retailer's location and/or the user's personalization settings. In step 114, the location-aware advertisement can be generated. In some examples, content for the location-aware advertisement can be pulled from third-party advertiser servers. The location-aware advertisement campaign application server can generate the location-aware advertisement in the form of a text message. In other example embodiments, the location-aware advertisement can be generated in a format based on mobile device capability. For example, if the mobile device is a smart phone, the location-aware advertisement can be in a rich media format such as a text, audio, still images, animation, video, or interactivity content forms and/or any combination thereof The location-aware advertisement can include coupon offers and/or codes. In step 116, the location-aware advertisement can be forwarded to the user's mobile device. Step 116 can be performed according to any parameters specified by the user. For example, the location-aware advertisements can be provided at intervals specified by the user. In step 120, it is determined if the user's mobile device is still within the geozone and/or time period parameters specified by the user. If so, the user can continue to receive relevant location aware advertisements. If not, in step 122, the location-aware advertisement campaign can be terminated.

FIG. 1B depicts an example process 144 of a messaging service for location-aware mobile resource management (MRM) with a mobile device triggered by tagged user-generated messages, according to some embodiments. A user can be an employee or a company that utilizes location-aware MRM.

In step 124 of process 144, a user composes a tagged text message with a mobile device and sends the tagged text message to a server. The server can be an MRM application server. The MRM application server can operate independently of a short message service center (SMSC) server (e.g. be communicatively coupled with the SMSC via the Internet, connect to a messaging gateway) and/or be incorporated into an SMSC server (e.g. as a local value-added service (VAS) server), according various embodiments. The MRM server can include a mobile resource management system that can include such functionalities as inventory management, customer communications, route planning (e.g. use statistical historical data that can aid in better and more accurate route planning), job assignment allocation, organizational management, fleet management, company logistics and the like. The tag can include an alpha-numeric and/or symbolic code that is entered into the text portion of the text message. The text message can be sent to the MRM application server (e.g. via an SMSC). A user can utilize various tags to instruct the MRM application server to implement a location-aware MRM service according to various parameters (e.g. while the user is in a particular location and/or for a specified period of time). In some embodiments, these parameters can be preloaded by the user via a web interface that allows the user (or the user's coworkers and/or supervisors) to provide profile information and/or preferences to the MRM application server (see infra). In some embodiments, these parameters can be specified by the user in the text message as a tag (see infra). It is noted that the SMSC can forward a tagged text message to the MRM application server for parsing and interpretation.

Additionally, the user's tags can serve as instructions to a rule engine in the MRM application server as to which conditions such as when, what, where and how to communicate MRM instructions to the user. For example, a tag can indicate that the user is would like to receive a next delivery assignment, a work order, a service assignment, driving instructions to a work site, the user is not available for a time period (e.g. taking a lunch break for one hour), and the like.

In step 126, a rule engine (such as a module in the location-aware advertisement campaign application server) can then interpret the tag(s) and/or message content. The rule engine can also utilize other metadata such as user mobile device network information, location information, user profile information and the like. Thus, in step 128, the profile information of the user is obtained. The rule engine can utilize the tags, message content, profile information, and/or metadata to determine an appropriate instruction to send to the user's mobile device. The rule engine can also pull information from a MRM module that supplies a list of available MRM-related tasks (such as those obtained from a mobile resource management system) to the rule engine to match with information from the user-generated text message (e.g. tags) and information pulled from the user's mobile device and/or network (e.g. location, profile). In this way, location-aware MRM service assignments (as well as other MRM information such as customer feedback, route information, etc.) can be provided to the user via text message.

In step 130, the user's mobile device location is determined and tracked. Step 130 can be triggered and performed according to a tag input by the user in tagged text message in step 124 instructing the MRM application server to track the user's mobile device. The mobile device's location can be tracked with any available geolocation methodology. The MRM application server can include a tracking module that tracks subscribing mobile devices such as those for field workers for a company. For example, it can be determined if a user's mobile device is within a particular geozone. Work orders relevant to the geozone can then be provided to the user as text messages to the mobile device (see step 134-138 infra).

In step 132, a confirmation message can be sent back to the user's mobile device. The confirmation message can indicate such conditions as confirming that the location-aware MRM service has been initiated, confirming that the instructions indicated by the tag(s) have been received and/or any parameters of the location-aware MRM.

In step 134, at least one relevant location-aware MRM instruction is determined. For example, the location-aware MRM can be determined by the rules engine. In step 136, the location-aware MRM instruction can be generated. In some examples, content for the location-aware MRM instruction can be pulled from third-party servers and/or a company mobile resource management application that provides tasks to employees. The location-aware MRM instruction can be in the form of a text message. In step 138, the location-aware MRM instruction can be forwarded to the user's mobile device. Step 138 can be performed according to any parameters specified by the user. For example, the location-aware MRM instruction can be provided at intervals and/or according to a change in location of the user. In step 140, it is determined if the user's mobile device is still within the geozone and/or time period parameters specified by the user. 117 so, the user can continue to receive relevant location-aware MRM instructions. If not, in step 142, the sending of location-aware MRM instructions can be terminated.

It is noted that process 100 and process 144 of FIGS. 1A-B do not require that a new application be installed with the mobile device. Instead, the mobile device merely serves as a means of generating tagged text messages (with the native text messaging applications) and receiving remote server generated responses to the user-generated tagged text messages. In this way, data processing operations are offloaded from the mobile device to a remote server. Accordingly, the tags serve as a method of ‘pulling’ information from a remote server when a user requests said information rather than having the information automatically pushed to a native application in the mobile device.

Exemplary Environment and Architecture

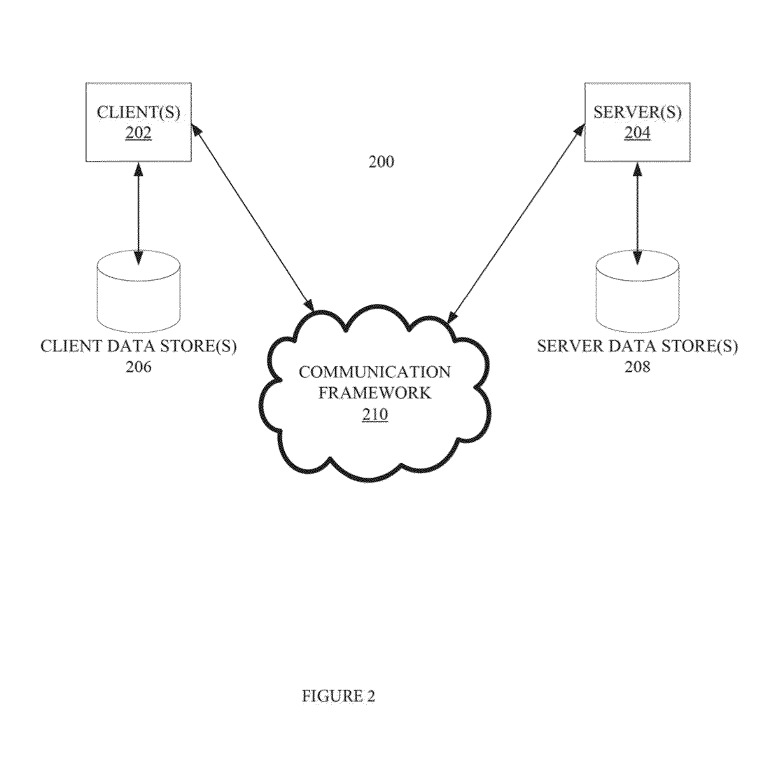

FIG. 2 is a block diagram of a sample computing environment 200 that can be utilized to implement some embodiments. The system 200 further illustrates a system that includes one or more client(s) 202. The client(s) 202 can be hardware and/or software (e.g., threads, processes, computing devices). The system 200 also includes one or more server(s) 204. The server(s) 204 can also he hardware and/or software (e.g., threads, processes, computing devices). One possible communication between a client 202 and a server 204 may be in the form of a data packet adapted to be transmitted between two or more computer processes. The system 200 includes a communication framework 210 that can be employed to facilitate communications between the client(s) 202 and the server(s) 204. The client(s) 202 are connected to one or more client data store(s) 206 that can be employed to store information local to the client(s) 202. Similarly, the server(s) 204 are connected to one or more server data store(s) 208 that can be employed to store information local to the server(s) 204.

In some embodiments, system 200 can be include and/or be utilized by the various systems and/or methods described herein to implement process 100. For example, the specified content of step 102 can be stored in 206 and/or 208. User login verification can be performed by server 204. Client 202 can be in a web browser operating on a computer such as a personal computer, laptop computer, mobile device e.g. a smart phone) and/or a tablet computer.

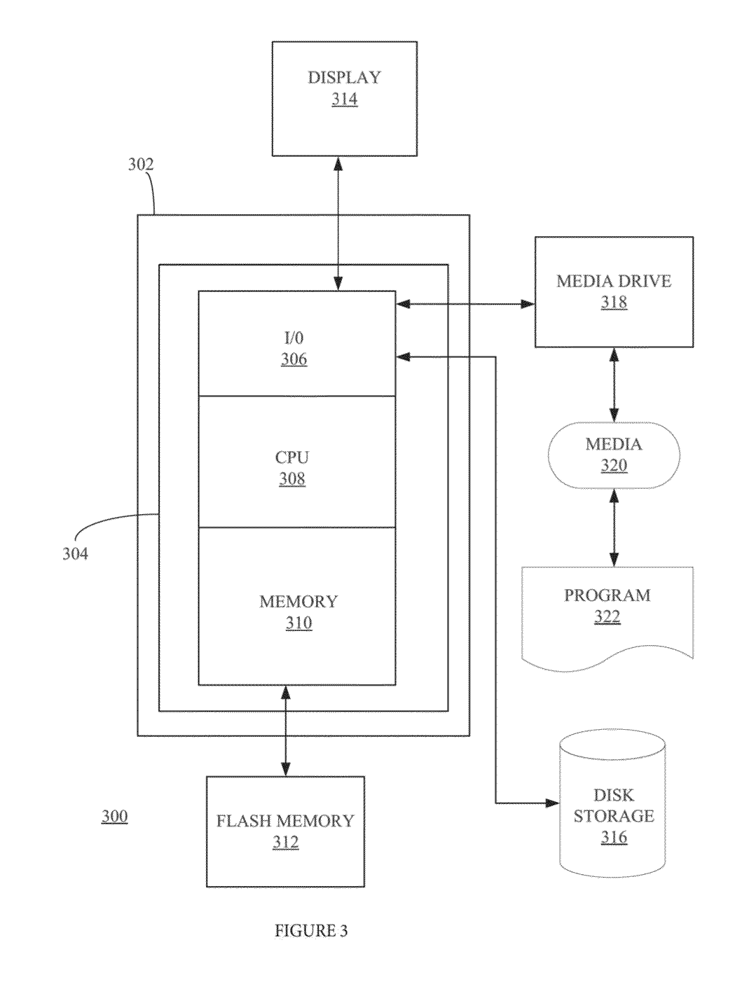

FIG. 3 depicts an exemplary computing system 300 that can be configured to perform any one of the processes provided herein. In this context, computing system 300 may include, for example, a processor, memory, storage, and I/O devices (e.g., monitor, keyboard, disk drive, Internet connection, etc.). However, computing system 300 may include circuitry or other specialized hardware for carrying out some or all aspects of the processes. In some operational settings, computing system 300 may be configured as a system that includes one or more units, each of which is configured to carry out some aspects of the processes either in software, hardware, or some combination thereof.

FIG. 3 depicts computing system 300 with a number of components that may be used to perform any of the processes described herein. The main system 302 includes a motherboard 304 having an I/O section 306, one or more central processing units (CPU) 308, and a memory section 310, which may have a flash memory card 312 related to it. The I/O section 306 can be connected to a display 314, a keyboard and/or other user input (not shown), a disk storage unit 316, and a media drive unit 318. The media drive unit 318 can read/write a computer-readable medium 320, which can contain programs 322 and/or data. Computing system 300 can include a web browser. Moreover, it is noted that computing system 300 can be configured to include additional systems in order to fulfill various functionalities. For example, computing system 300 can be configured to be telecommunications server such as an MRM application server and/or a location-aware advertisement campaign application server (e.g. can include API's and other systems to access data from the mobile device's network). In another example, computing system 300 can be configured as a mobile device and include such systems as may be typically included in a mobile device such as GPS systems, gyroscope, accelerometers, cameras, etc.

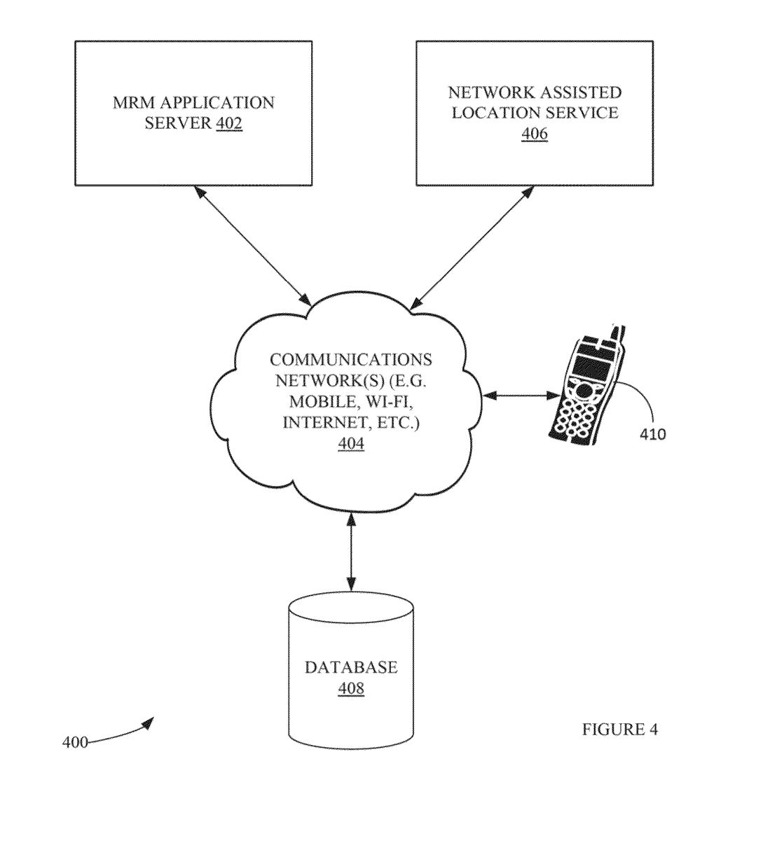

FIG. 4 depicts an example location-aware MRM system 400, according to some embodiments. FIG. 4 depicts an MRM application server 402. A user utilizes a mobile device 410 with no native MRM application to draft and send a tagged SMS message (e.g. “Job done ##”) to the MRM application server 402. The user's company can interface with the MRM application server 402 to set up various MRM functionalities such as geozones (e.g. physical regions), tag instructions, MRM rules and the like. For example, the tag, “Job done ##”, can indicate that the user has completed a specified task and is requesting another task within the user's assigned geozone. The MRM application server 402 can include a rule engine that interprets tags, processes rules, determines mobile device's 410 location, stores transaction history and/or message data, and the like (e.g. in database 408). The rule engine can also connect to third-party enterprise systems to implement other functionalities such as dispatches, USPS reports, time and attendance management, mapping service applications, etc. The MRM application server 402 can also utilize various methodologies to track the location of the mobile device 410 (such as those listed supra). For example, MRM application server 402 can query a network-assisted location service 406 to obtain a substantially current location of the mobile device 410. The location of the mobile device 410 can then be combined with the MRM functionalities to create an MRM instruction for the user such as a location-aware job-related SMS message. Examples of location-aware job-related SMS message include, inter alia, “Go to 123 Broadway and deliver next package”, “Fix plumbing at Hanson Office Building”, and/or “follow attached route to next job” (with link to web-implemented map and route attached to message). Again, it is noted that the mobile device 410 does not include a specialized application for implementation of the MRM functionalities, but rather utilizes, inter alia, the native text messaging application. In this way, the user can initiate an MRM function by composing a text message with a pre-defined tag and sending the tagged text message to a MRM application server 402 at a specified address/number (e.g. can be forwarded by an SMSC). The various elements of FIG. 4 can communicated via one or more communication networks 404.

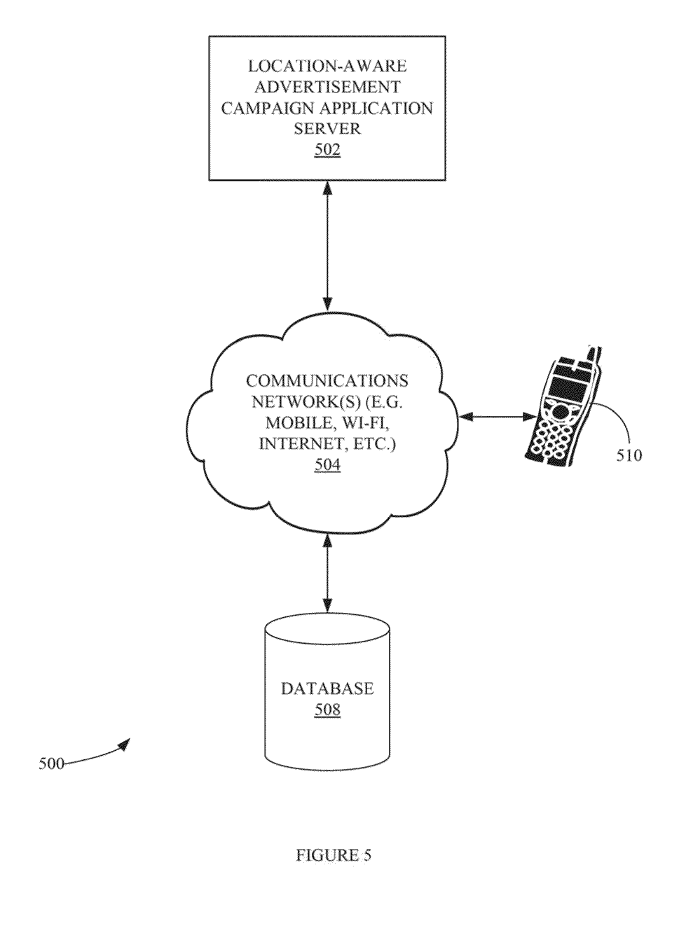

FIG. 5 depicts an example location-aware system 500 utilized for location-aware advertisement campaigns, according to some embodiments. A user utilizes a mobile device with no native location-aware advertisement campaign application to draft and send a tagged SMS message “‘Coffee ##’” to the location-aware advertisement campaign application server 502. Third-party enterprises can interface with the location-aware advertisement campaign application server 502 to set up various advertisement campaigns in specified geozones. For example, the tag “Coffee ##” can indicate that the user would like to receive various advertisements and/or coupons for coffee shops nearby. The location-aware advertisement campaign application server 502 can then pull advertisements and/or coupons for coffee shops located within the user's current geozone from a preset campaign stored in a database 508 and/or from an API provided by advertising third-party enterprises (e.g. Starbucks®). These advertisements can then be put into text message format (e.g. SMS, MMS with map image, etc.) and sent back to the user's mobile device. Users can also utilize tags to set other advertisement campaign parameters such as time period of campaign, size of geozone, maximum number of advertisements to send, stop advertisement campaign, etc.

The location-aware advertisement campaign application server 502 can include rule engine that interprets tags, processes rules, tracks mobile device location, stores transaction history and/or message data, and the like. The rule engine can also connect to third-party enterprise systems to obtain various relevant data such as advertisements for particular goods and/or services, coupons, maps, etc. The location-aware advertisement campaign application server 502 can also utilize various methodologies to track the location of the mobile device (such as those listed supra). Again, it is noted that the mobile device does not include a specialized application for implementation of the location-aware advertisement campaign functionalities, but rather utilizes, inter alia, the native text messaging application and information obtained from the mobile device's network(s). In this way, the user can initiate a location-aware advertisement campaign function by merely composing a text message with a pre-defined tag and sending the tagged text message to a location-aware advertisement campaign application server 502 at a specified address/number. The various elements of FIG. 5 can communicated via one or more communication networks 504.

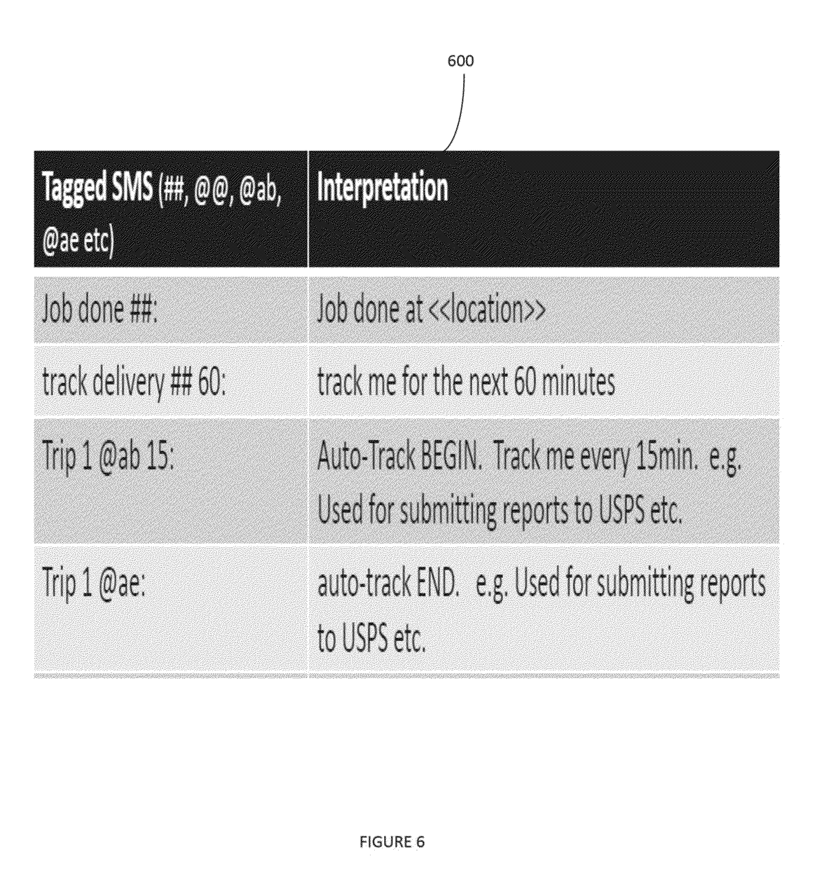

FIG. 6 depicts a table 600 with a set of example MRM-related user tags and corresponding interpretations for the rule engine, according to some embodiments. SMS tags can include a mixture of human-readable text and/or sequences of symbols. The present tags and instructions in FIG. 6 are provided for exemplary purposes only and other embodiments are not limited thereby. Moreover, users can pre-input various tags and interpretations to the MRM application server 402 through a web interface.

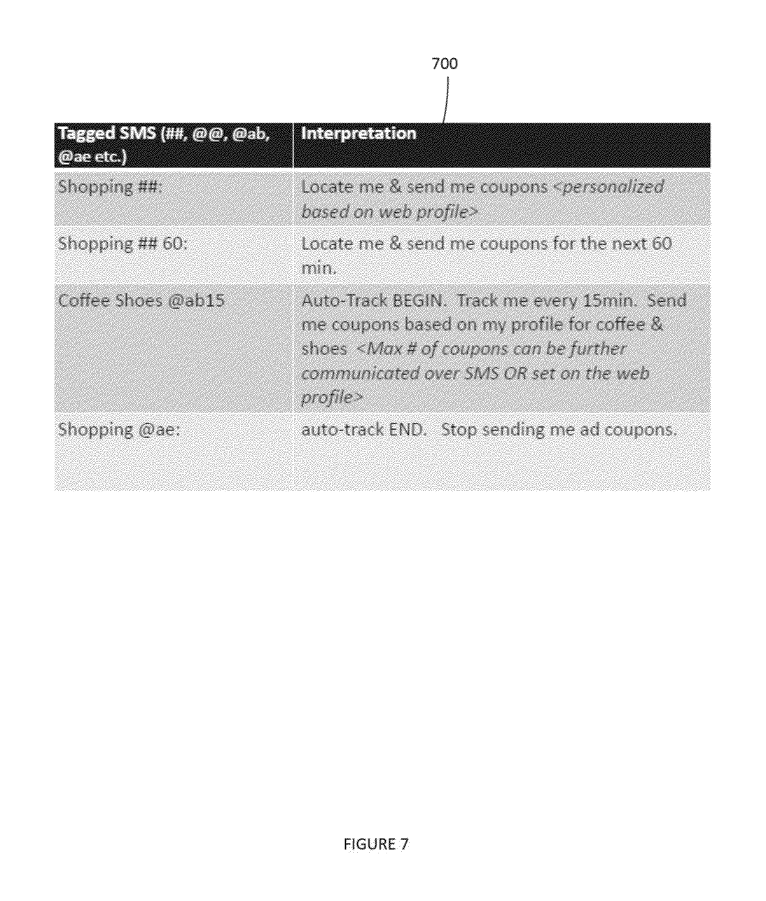

FIG. 7 depicts a table 700 with a set of example location-aware advertisement campaign-related user tags and corresponding interpretations for the rule engine, according to some embodiments. SMS tags can include a mixture of human-readable text and/or sequences of symbols. The present tags and instructions in FIG. 7 are provided for exemplary purposes only and other embodiments are not limited thereby. Moreover, users can pre-input various tags and interpretations to the location-aware advertisement campaign application server through a web interface. In this way, users can compose and/or personalize their own tags. Alternatively, users can utilize predefined system tags as well.

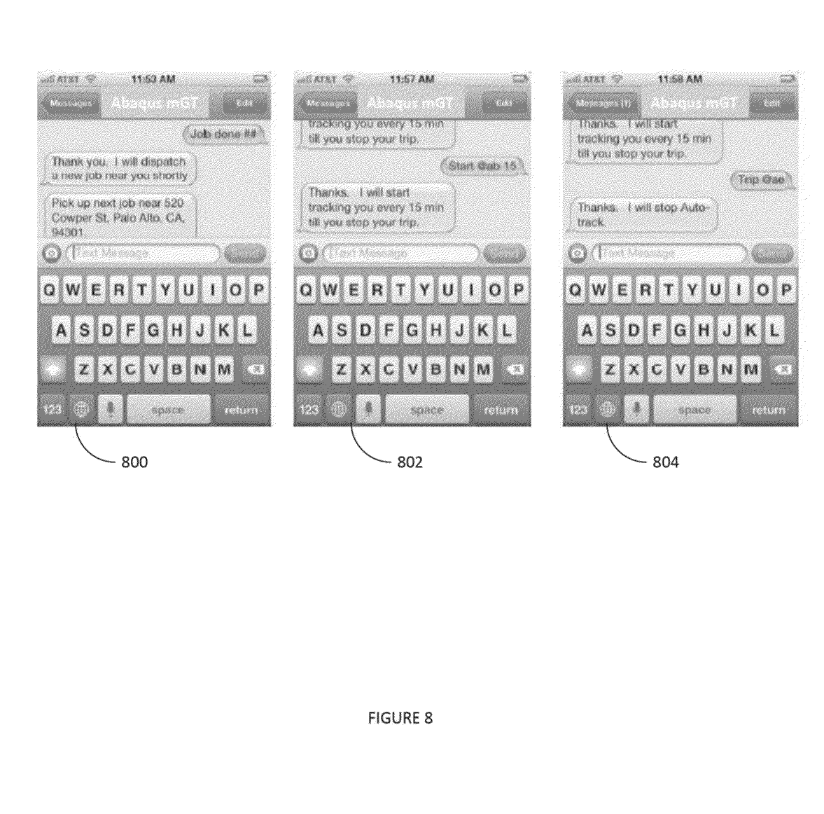

FIG. 8 illustrates several exemplary user-side mobile device screen shots 800-804, according to some embodiments. Text messages between the user's mobile device and the MRM application server can be provided in various graphical formats. FIG. 8 depicts a scrolling format wherein the GUI presents a kinetic display that allows the user to slide vertically arranged text messages in a linear temporal order. FIG. 8 depicts several user-generated tagged text messages addressed to the MRM application server 402 as well as appropriate MRM application server responses.

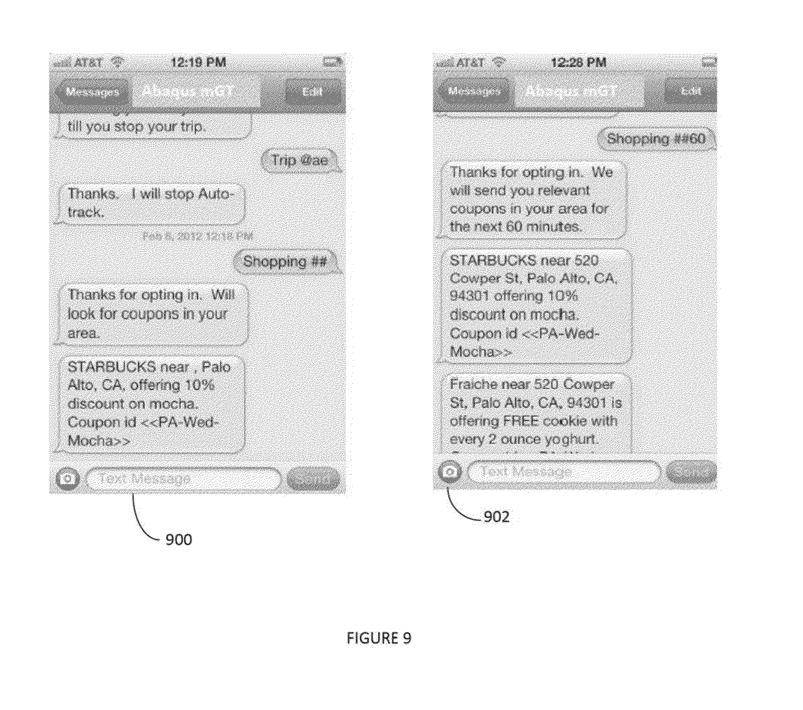

FIG. 9 illustrates several exemplary user-side mobile device screen shots 900-902 including a pull-based, location-specific advertisement and/or coupons, according to some embodiments. In the particular example of FIG. 9, the user can opt out of a location-aware advertisement campaign by sending the tagged SMS to the location-aware advertisement campaign application server of “Trip @ae”. The rule engine of the location-aware advertisement campaign application server interprets the message and ceases tracking the mobile device's location. When the user later sends a tagged text message of “Shopping ##”, the rule engine instructs the location-aware advertisement campaign application server to begin tracking the mobile device and send the mobile device any available coupons in the particular geozone where the mobile device is located. In this example, the location-aware advertisement campaign application server sends the mobile device ten percent (10%) off coupon for a nearby Starbucks® in the Palo Alto geozone. It is noted that this particular tagged text message switched the state of the user's account to opt in to receiving available location-aware advertisements without any termination event. In another screen shot, the user sends the location-aware advertisement campaign application server a tagged SMS of “Shopping##60”. In this example, the user has opted into the location-aware advertisement campaign for sixty minutes after which the location-aware advertisement campaign terminates. The location-aware advertisement campaign application server sends the user and acknowledgement message providing the current state of the user's account with the location-aware advertisement campaign application server. Additionally, the user begins to receive various location-aware advertisements in SMS format as depicted in the screen shot. It is noted that other tag can be utilized to set up a variety of options regarding opt in time periods. For example, future time periods can be set up with certain tags such as “next week”, “in two hours for four hours”, “when I arrive at the Costa Mesa mall” and the like.

It is noted tat a telecommunications networks can use service delivery platforms to expose their network resources and assets to internal and external development communities. This process can include classes of resource such as communication (e,g, voice, text, IM, conferencing, etc.); commerce (e.g. payments, refunds etc.); and security (e.g. identity, trust, etc.). A tagged SMS message can be used by end-users to ‘interact with’ and ‘control’ these network resources in the context of many consumer and business applications. The tagged SMS may also be utilized to leverage native device sensors to further enhance their interaction with the aforementioned network resources in the context of the consumer and business app. For example, an application provider may desire to deliver relevant hi-quality rich media advertisement to a consumer. The application provider can register a long code or a short code (e.g. a phone number). The end user can send an SMS “@@i” to this phone number whenever he would like to have targeted advertisements delivered to his device (e.g. while he is shopping). The application provider (on the web) processes this SMS and accordingly, it has the permission to perform various functions such as, inter alia: request the mobile network for the user's location; request the mobile network for the details on the user's subscriber profile (e.g. user's phone IMEI number, model, device capabilities such as type of camera, video player, sound quality, and/or other microelectromechanical (MEM) sensor capabilities). Based on this device profile data, the application (server-side) can create and deliver targeted advertisements to the end-user. These advertisements can be uniquely targeted to the end-user device to playback in a high-definition video format, utilize additional MEM sensors to orient and point to the exact retail store in the vicinity, etc.

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method comprising:
receiving a text message from a mobile device, wherein the text message comprises a tag entered into the text portion of the message, and wherein the tag comprises term assigned to a server-side process;
obtaining a location of the mobile device;
determining the server-side process based on the tag and the location of the mobile device;
implementing the server-side process;
composing an instruction to a user of the mobile device; and
formatting the instruction into a text message format.

2. The method of claim 1, wherein the server-side process comprises a location-aware advertisement campaign.

3. The method of claim 2, wherein the location-aware advertisement campaign comprises the steps of:
determining a substantially current geozone of the mobile device based on the location of the mobile device;
matching the substantially current geozone with at least one advertisement, wherein the advertisement pertains to a business entity located in the substantially current geozone;
formatting the advertisement into a text message format; and
communicating the advertisement to a text messaging application in the mobile device.

4. The method of claim 1, wherein the server-side process comprises a mobile-resource management process.

5. The method of claim 4, wherein the mobile device does not comprise a specialized mobile resource management client application.

6. The method of claim 5, wherein the mobile-resource management process comprises the steps of:
determining at least one mobile resource management instruction based on the location of the mobile device; and
generate a location-aware mobile resource management message based on the least one mobile resource management instruction.

7. The method of claim 1, wherein the tag comprises a preset alpha-numeric code.

8. The method of claim 1, wherein the location of the mobile device is determined by querying a cellular network associated with the mobile device.

9. The method of claim 1, wherein the text message comprises a short messaging system (SMS) message.

10. A server system for implementing a location-aware advertisement campaign through text message comprising:
a processor configured to execute instructions;
a memory containing instructions when executed on the processor, causes the processor to perform operations that:
receiving a text message from a mobile device, wherein the text message comprises a tag entered into the text portion of the message, and wherein the tag comprises term assigned to a location-aware advertisement campaign;
obtaining a location of the mobile device;
determining a substantially current geozone of the mobile device based on the location of the mobile device;
matching the substantially current geozone with at least one advertisement, wherein the advertisement pertains to a business entity located in the substantially current geozone;
formatting the advertisement into a text message format; and
communicating the advertisement to a text messaging application in the mobile device.

11. The server system of claim 10, wherein the text message comprises a short messaging system (SMS) message.

12. The server system of claim 10, wherein a location-aware advertisement campaign application is not installed in the mobile device.

13. The server system of claim 10, wherein the tag comprises a user-provided parameter.

14. The server system of claim 13, wherein the parameter comprises a period of time for the server system to provide advertisements to the mobile device.

15. The server system of claim 14,
wherein the advertisement comprises a coupon for a type of good identified by the user in the tag, and
wherein the tag comprises a user-designated i to relocate the mobile device.

16. A server system for implementing a mobile-resource management process through text message comprising:
a processor configured to execute instructions;
a memory containing instructions when executed on the processor, causes the processor to perform operations that;
receiving a text message from a mobile device, wherein the text message comprises a tag entered into the text portion of the message, and wherein the tag comprises term assigned to a mobile-resource management process;
obtaining a location of the mobile device;
matching the substantially current geozone with at least one task for a user of the mobile device;
generating an instruction to the user to perform the task; and
messaging the task to a text messaging application in the mobile device.

17. The method of claim 16, wherein the tag indicates that the user has completed a specified task and is requesting another task within an assigned geozone.

18. The method of claim 16, wherein tag instructs a mobile resource management server to automatically track the location of the mobile device at an interval specified in the tag.

19. The method of claim 16, wherein a mobile resource management application is not installed in the mobile device.

20. The method of claim 16, wherein the mobile resource management application queries a mobile device's mobile network to obtain a mobile device microelectromechanical sensor profile.
